(19) United States
(12) Patent Application Publication
(10) Pub. No.: US 2026/0061653 A1
(43) Pub. Date: Mar. 5, 2026

(54) DEVICE FOR CUTTING ELECTRODE FOILS

(71) Applicant: VARTA Microbattery GmbH, Ellwangen Jagst (DE)

(72) Inventors: Nils Barenthin, Ellwangen (DE); Andreas Gaugler, Ellwangen (DE); Daniel Kienle, Nördlingen (DE)

(21) Appl. No.: 19/305,913

(22) Filed: Aug. 21, 2025

(30) Foreign Application Priority Data
Aug. 29, 2024 (EP) 24197143

(51) Int. Cl. B26D 7/26; B26D 1/24

(52) U.S. Cl. CPC B26D 7/2628; B26D 1/245

(57) ABSTRACT

A device for cutting a strip-shaped electrode foil into narrower strips has two parallel driven shafts and two pairs of circular blades that are attached to the shafts. An elastic element is arranged between the blades of one shaft and presses them against the blades on the other shaft. Each circular blade has a radially outwardly facing cylindrical outer surface and a flat annulus-shaped side surface that extends perpendicular to the respective axis of rotation and forms a circumferential cutting edge where it adjoins the outer surface. The cutting edges of the second circular blades have a similar construction, but face each other and are separated by a circumferential interspace. A non-destructively exchangeable spacer element is arranged between the two second circular blades, thereby determining the axial width of the interspace.

### CROSS-REFERENCE TO RELATED APPLICATIONS

This application claims benefit to European Patent Application No. EP24197143.1 filed on Aug. 29, 2024, the disclosure of which is hereby incorporated by reference in its entirety.

### FIELD

The present disclosure relates to a device with which electrode strips can be cut into narrow strips during battery production.

### BACKGROUND

The term “battery” originally meant several galvanic cells connected in series. Today, however, individual galvanic cells are also often referred to as batteries. When a galvanic cell is discharged, an energy-producing chemical reaction takes place, which combines two electrically coupled but spatially separated partial reactions. Electrons are released at the negative electrode in an oxidation process, resulting in a flow of electrons via an external consumer to the positive electrode, from which a corresponding quantity of electrons is absorbed. A reduction process therefore takes place at the positive electrode. At the same time, an ion current corresponding to the electrode reaction occurs within the cell. This ion current is enabled by an ion-conducting electrolyte. In secondary cells and batteries, this discharge reaction is reversible, i.e. it is possible to reverse the conversion of chemical energy into electrical energy during discharge.

Among the known secondary cells and batteries, comparatively high energy densities are achieved by lithium-ion batteries in particular. In many cases, these contain a cell stack consisting of several individual cells. However, batteries with very high capacities in particular usually have wound cells (coils or jellyrolls). These can be produced at very high speed and, as a result, at comparatively low cost.

Coiled cell technology is suitable for the construction of both prismatic cells and round cells.

The cells of a lithium-ion battery are usually an ensemble of electrode and separator foils with the sequence positive electrode/separator/negative electrode. Such individual cells are often manufactured as so-called bi-cells with the possible sequences negative electrode/separator/positive electrode/separator/negative electrode or positive electrode/separator/negative electrode/separator/positive electrode. The electrodes usually comprise metallic current collectors, which are mostly in the form of flat structures.

The cells described for lithium-ion cells are generally produced in a multi-stage method. Such methods are known, for example, from DE 10 2010 032 770 A1 or from US 2010/0081052 A1.

In most common methods, the electrode foils mentioned are produced in a first step and then combined with one or more separator foils to form the electrode-separator ensembles mentioned. In most cases, electrodes and separators are assembled in a lamination step. However, they can also be handled further in the form of a loose ensemble.

To produce the electrode foils, an electrode tape is manufactured, which consists of an electrically conductive collector tape and an electrode material applied to one or both sides. The electrode material is usually applied to the collector tape in the form of a highly viscous mass by means of a suitable nozzle and/or using a squeegee, wherein this application of the electrode mass is preferably carried out quasi-continuously by guiding the collector tape along an application station. Usually, edge regions of the collector belt extending in the conveying direction and/or also central subregions remain free of electrode material, for example in order to use these regions later as contact regions for arresters. After the electrode material has been applied, there is usually a drying station where the carrier solvent escapes from the electrode mass. The remaining dried electrode material is usually interspersed with pores, so that compaction usually follows to achieve a higher energy density. This is also described by the term calendering.

The electrode foil is then cut into smaller pieces, which are cut to the dimensions of the electrodes to be formed. In winding cells, the electrode foil is cut into narrow strips before these are wound onto a winding core.

This cutting process is technologically demanding. As the dried and compacted electrode material is brittle, electrode material can splinter off during mechanical cutting using rotating circular blades, resulting in unclean cutting edges on the electrode foil. This in turn causes the electrode strips to shift sideways during subsequent winding (“lateral misalignment”). Electrode strips that are not wound precisely in this way generally impair the performance and service life of the subsequent battery. The lateral misalignment during winding leads to a quality defect that cannot be tolerated in high-quality products and consequently leads to rejects.

In addition, the chipped electrode material can sometimes settle on the circular blades in the form of small particles, despite the use of suction devices. This has a negative effect on the cutting quality, causing even more electrode material to flake off.

In order to ensure the high quality of the cutting edges, laser scanners are sometimes used to detect chipping and waviness and can intervene directly in the control of the cutting process if necessary. In this way, it is also possible to recognize at an early stage when the circular blades need to be resharpened. However, the fundamental problem of uneven cutting edges cannot be solved by such monitoring.

As already mentioned, mechanical cutting devices contain rotating circular blades that are arranged next to each other on a common shaft at a distance from the desired cutting lines. A second such arrangement is located on the opposite side of the electrode foil and forms corresponding counter blades. Opposite circular blades work together in a similar way to the blades of a pair of scissors and produce the desired cut.

The basic structure of such a mechanical cutting device is known, for example, from US 2014/0149485 A1. The cutting edge of one circular blade is defined by two inclined surfaces and engages in a V-groove, which is formed as on the opposite circular blade. This design of the circular blade is intended to improve its service life.

Other geometries of the circular blades are known from US 2022/0140304 A1. The lower circular blade has a cylindrical outer surface and a flat side surface that runs perpendicular to the respective axis of rotation. The cutting edge is formed by the circumferential edge at which the two surfaces adjoin each other at an angle of 90°. The outer surface of the upper circular knife is not cylindrical, but comprises two differently inclined partial surfaces. These define a circumferential cutting edge with which the upper circular blade plunges into the electrode foil during the cutting process. This design of the circular blade is intended to reduce the release of dust and other particles during the cutting process.

However, the problem of unclean and uneven cutting edges also exists with the mechanical cutting devices described above.

Cutting devices are also known in which the electrode foil is cut without contact using a laser beam. However, the heat input can cause the electrode material with which the electrode strip is coated to melt locally, which is generally undesirable. Thus, there is a need for an improved cutting device for cutting a strip-shaped electrode foil into narrower strips, with which more even and cleaner cutting edges can be produced.

### SUMMARY

In an embodiment, the present disclosure provides a device for cutting a strip-shaped electrode foil into narrower strips has two parallel driven shafts and two pairs of circular blades that are attached to the shafts. An elastic element is arranged between the blades of one shaft and presses them against the blades on the other shaft. Each circular blade has a radially outwardly facing cylindrical outer surface and a flat annulus-shaped side surface that extends perpendicular to the respective axis of rotation and forms a circumferential cutting edge where it ad-joins the outer surface. The cutting edges of the second circular blades have a similar construction, but face each other and are separated by a circumferential interspace. A non-destructively exchangeable spacer element is arranged between the two second circular blades, thereby determining the axial width of the interspace.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following which:

FIGS. 1a and 1b illustrate the division of electrode strips into narrow strips as well as the immediately upstream and downstream production steps during the manufacture of batteries according to two different variants.

FIG. 2 is a longitudinal section of a cutting device according to a first embodiment.

FIG. 3 is an enlarged section of FIG. 2.

FIG. 4 is a longitudinal section through a cutting device according to a second embodiment, in which the cutting device comprises an ejector ring.

FIG. 5 is a cross-section through the cutting device shown in FIG. 4 along the line V-V.

FIG. 6 is a longitudinal section through a cutting device according to a third embodiment, in which an elastic element is located between two first cutting blades.

FIG. 7 is a longitudinal section through a cutting device according to a fourth embodiment, in which several groups of circular blades are arranged to cut a total of nine strips.

FIG. 8 is a photograph of an electrode strip cut with a conventional cutting device.

FIG. 9 is a photograph of an electrode strip cut by a cutting device according to an embodiment.

### DETAILED DESCRIPTION

A device for cutting a strip-shaped electrode foil into narrower strips according to an aspect of the present disclosure comprises a first shaft and a second shaft which extends parallel to the first shaft. The device has a drive which is configured to set the first shaft and the second shaft in counter-rotation. A first pair of first circular blades is attached to the first shaft in a rotationally fixed manner. A second pair of second circular blades is attached to the second shaft in a rotationally fixed manner. Each circular blade has a radially outwardly facing cylindrical outer surface and a flat annulus-shaped side surface which extends perpendicular to the respective axis of rotation and forms a circumferential cutting edge where it adjoins the outer surface. The cutting edges of the second circular blades of the second pair face each other and are separated from each other by a circumferential space. The cutting edges of the first circular blades of the first pair face away from each other and engage in the interspace in such a way that adjacent first and second circular blades cooperate to produce a respective cutting edge in the electrode foil.

The disclosure is based firstly on the consideration that in most cutting devices known in the prior art, the cutting edges are asymmetrical, i.e. defined by two cutting surfaces which include different angles to the plane in which the respective circular knife extends. If several such cutting edges are arranged next to each other, the cutting edges produced on both sides of the cutting edge are also different. In the cutting device according to the present disclosure, on the other hand, two cutting edges whose cutting surfaces are arranged at an angle of 90°to each other work together to produce a cut. As a result, both cutting edges of each electrode strip are produced with exactly the same cutting geometry, which prevents deviations between the opposing cutting edges.

Furthermore, not only are the cutting edges of each individual strip identical, but also the cutting edges of neighboring strips, so that all strips produced by the device have cutting edges of consistently high quality.

One of the factors contributing to the high cutting quality is that the cutting surfaces defining the cutting edges are arranged at an angle of 90°to each other and therefore have a longer service life than narrow knife-like cutting edges. In addition, the cylindrical outer surfaces of the two circular blades allow the electrode foil to rest flat on the outer surfaces of the circular blades, which prevents high point loads and strong curvature of the electrode foil. This leads to a gentler cut overall and, as a result, to cutting edges in which less electrode material splinters off.

As the two first circular blades engage together in the interspace, it is basically possible to form the two first circular blades of the first pair in one piece. However, this places very high demands on the manufacturing accuracy, as the two first circular blades should pass the second circular blades with a predetermined contact pressure. Similar to conventional scissors, the contact pressure must not be too low, otherwise a clean cut cannot be achieved. If the contact pressure is too high, the friction between the circular blades is too high, which leads to unnecessary wear and problematic heat development.

In order to ensure optimum contact pressure of the first circular blades on the second circular blades, an elastic element can be arranged between the two first circular blades, which exerts a compressive force on the two first circular blades acting on the adjacent second circular blades. The elastic element can, for example, be a disk made of an elastomer, a compression spring or a disk spring. The elastic element ensures that the desired contact pressure is achieved between the interacting first and second circular blades.

During the cutting process, the electrode strip separated by the cutting edges of the first two circular blades is pressed slightly into the interspace. If the strip can withstand higher tensile loads, it can be pulled out of this interspace. However, strips that are only a few millimetres wide can tear off because the frictional forces at the cutting edges are just as great with narrow strips as with wide strips.

In order to prevent the cut-out electrode strip from winding up in the interspace and possibly tearing off when it is pulled out, an ejector ring can extend through the circumferential interspace, which ring is rotatably mounted to rotate about an axis of rotation that is independent of the second shaft and arranged eccentrically to it. Due to the eccentric arrangement, the cut-out strip is lifted out of the interspace in a radial direction by a preferably circular-cylindrical surface of the ejector ring. A drive for rotating the ejector ring about the axis of rotation is generally not required, as the cut-out strip, which is under tensile stress, carries the ejector ring along with low friction.

In order to realize an independent axis of rotation for the ejector ring, it can be supported on two rotatably mounted rollers. The ejector ring thus rests on the two rollers due to its own weight and is not attached to a central shaft.

In order to determine the width of the strips, a non-destructively exchangeable spacer element can be arranged between the two circular blades of the second pair, which determines the axial width of the interspace. For very small changes in the width of the cut-out strips, the first circular blades do not need to be adjusted if they are pressed against the second circular blades using the above-mentioned elastic element. If larger changes in the width of the strips are also to be possible, interchangeable spacer elements should also be provided between the first circular blades.

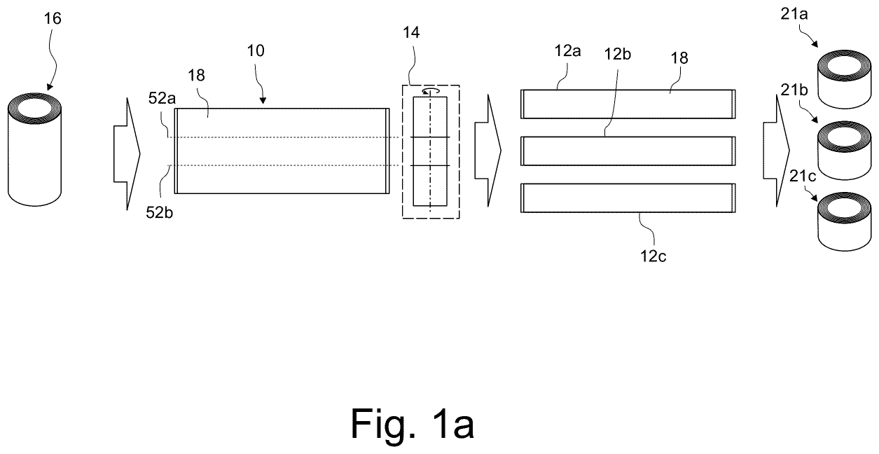

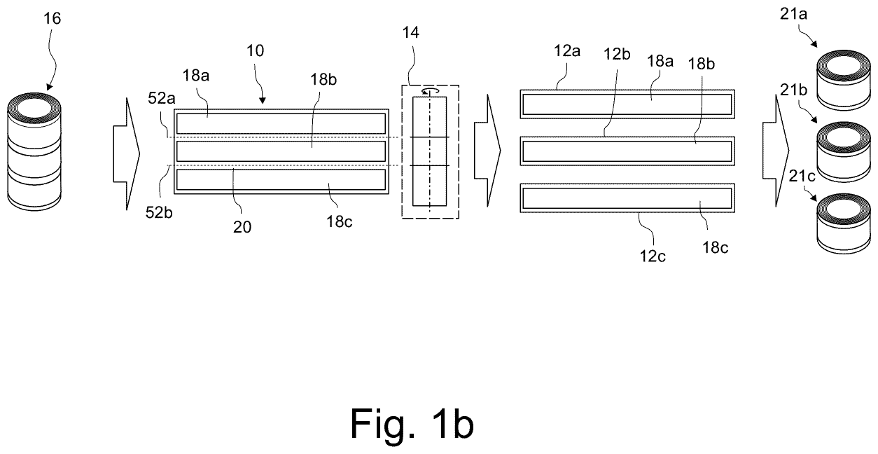

FIG. 1a schematically illustrates the separation of an electrode strip 10 into several narrow electrode strips 12a, 12b, 12c using a cutting device 14 according to a first variant.

As already described at the beginning, the electrode strip 10 is produced by coating one or both sides of a thin metallic collector foil. After drying and calendering, the electrode strip is normally rolled up into a roll of strip 16, which is shown on the left in FIG. 1a. The electrode strip 10 shown on the right is provided with a continuous coating 18 in the transverse direction in the embodiment shown.

With the aid of the cutting device 14, the electrode strip 10 is divided into the three electrode strips 12a, 12b, 12c so that each electrode strip 12a, 12b, 12c has the same width and is completely coated in the transverse direction. In this way, three identical electrode strips 12a, 12b, 12c are obtained. For the production of battery cells, the electrode strips 12a, 12b, 12c are generally wound around a winding core. The wound electrode strips 12a, 12b, 12c are indicated on the right in FIG. 1a and labeled 21a, 21b and 21c.

In the second variant shown in FIG. 1b, several individual coated regions 18a, 18b, 18c are separated from one another by uncoated regions 20.

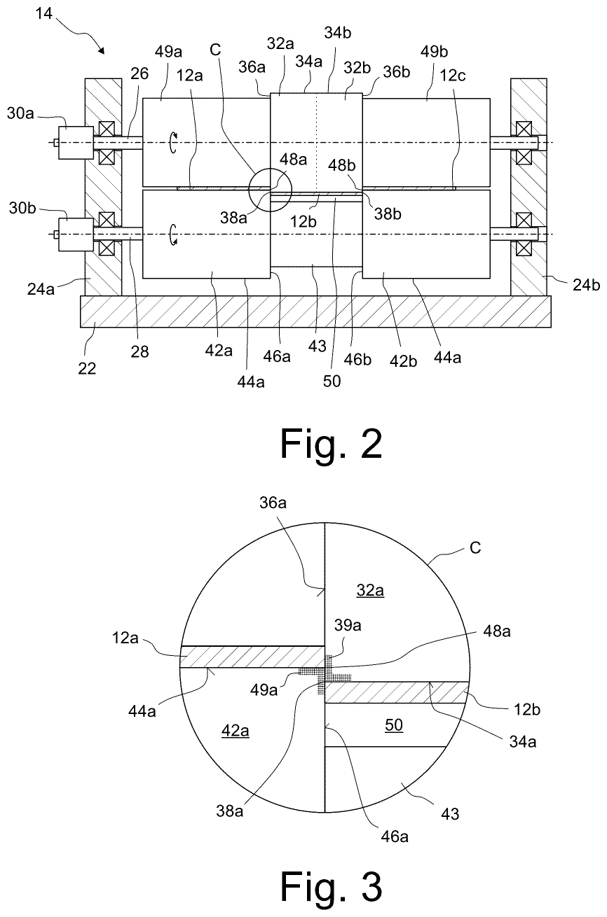

FIG. 2 shows the cutting device 14 schematically in an axial longitudinal section.

In the embodiment shown, the cutting device 14 comprises a base 22 which carries two opposing uprights 24a, 24b on which a first shaft 26 and a second shaft 28 are rotatably mounted.

In the embodiment shown, the cutting device 14 has two drives 30a, 30b, with the help of which the two shafts 26, 28 can be set in a counter-rotating rotary motion. The counter-rotation about the axes of rotation shown as dotted lines is indicated by arrows in FIG. 2. In the embodiment shown, each shaft 26, 28 is assigned its own drive 30a or 30b. In many cases, it is more expedient to use only one drive, which acts on both shafts 26, 28 via a suitable transmission.

A first pair of first circular blades 32a, 32b is attached to the first shaft 26 in a rotationally fixed manner. In the embodiment shown, the two circular blades 32a, 32b are formed as one piece; in an embodiment described further below, the two circular blades 32a, 32b are separate components. In order to be able to distinguish the two circular blades 32a, 32b in the embodiment shown in FIG. 2, a vertical dotted line is drawn, which can be regarded as a virtual boundary line between the two first circular blades 32a, 32b.

Each of the two first circular blades 32a, 32b has a radially outwardly facing cylindrical outer surface 34a or 34b and a flat annulus-shaped side surface 36a or 36b. The side surfaces 36a, 36b extend perpendicular to the axis of rotation of the first shaft 26 indicated by a dotted line and form a circumferential cutting edge where they adjoin the cylindrical outer surface 32a or 32b.

FIG. 3 shows an enlarged section C from FIG. 2, in which the cutting edge formed by the outer surface 32a and the side surface 34a is more clearly recognizable and is designated 38a. The cutting edge 38a is thus defined by two surfaces that are arranged at an angle of 90°to each other. The outer surface 34a and the side surface 36a of the first circular knife 32a are ground in an area indicated by a hatching 39a, in order to obtain a sharp cutting edge 38a.

The other first circular blade 32b differs from the circular blade 32a only in its mirror-symmetrical arrangement. The two cutting edges 38a, 38b thus face away from each other and therefore point towards the uprights 24a and 24b, respectively.

A second pair of second circular blades 42a, 42b is attached to the second shaft 28. In the embodiment shown, the distance between the second circular blades 42a, 42b is defined by a cylindrical spacer element 43. The two second circular blades 42a, 42b are constructed in the same way as the first circular blades 32a, 32b and accordingly each have a cylindrical outer surface 44a, 44b and flat annulus-shaped side surfaces 46a, 46b, which together with the outer surfaces 44a, 44b define cutting edges 48a, 48b.

In contrast to the first circular blades 32a, 32b, the cutting edges 48a, 48b of the second circular blades 42a, 42b face each other and are separated from each other by an interspace 50, the axial extent of which is defined by the spacer element 43. The cutting edges 38a, 38b of the first circular blades 32a, 32b engage in the interspace 50 in such a way that adjacent first and second circular blades cooperate to produce a respective cutting edge in the electrode strip 10. For this purpose, the electrode strip is fed in a plane perpendicular to the paper plane of FIG. 2 by means of transport rollers. Although the tangential speed of the circular blades 32a, 32b, 42a, 42b is generally significantly higher than the conveying speed of the electrode strip 10, the cylindrical outer surfaces 34a, 34b, 44a, 44b of the circular blades provide precise guidance of the electrode strip 10 in the cutting zone, so that the electrode strip 10 cannot deviate upwards or downwards there. This guidance can be supported by additional cylindrical guide rollers 49a, 49b without cutting functions, which are fixed to the first shaft 26 in a rotationally fixed manner.

As can be seen in the enlarged section of FIG. 3, the two interacting cutting edges 38a, 48a of the two circular blades 32a, 42a cut through the electrode strip 10 along two cutting lines, which are indicated by dashed lines 52a, 52b in FIGS. 1a and 1b. This divides the electrode strip 10 into three electrode strips 12a, 12b, 12c of the same width. The electrode strips 12a, 12b, 12c can then be wound up, as explained above with reference to FIGS. 1a and 1b.

Since the geometric conditions when cutting along the cutting lines 52a, 52b are identical, the cutting edges of the electrode strips 12a, 12b, 12c also all have the same quality.

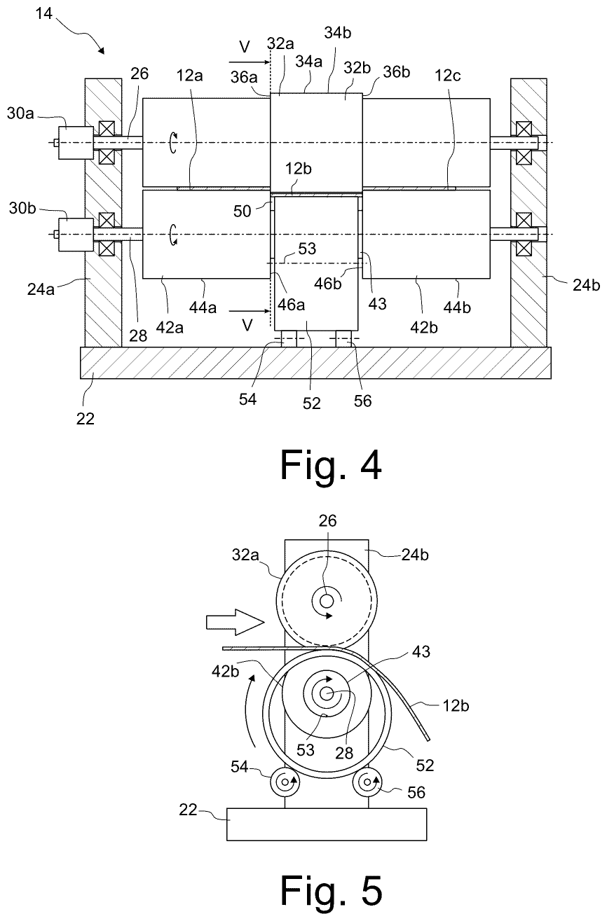

FIG. 4 shows a cutting device 14 according to a second embodiment. In the cutting device 14 shown there, the spacer element 43 between the two second circular blades 42a, 42b has a smaller diameter. As can best be seen in the cross-section along the line V-V shown in FIG. 5, an ejector ring 52 extends through a part of the interspace 50, which is rotatably mounted about an axis of rotation 53 that is independent of the second shaft 28 and extends parallel to but eccentrically with respect to the axis of rotation of the second shaft 28. In the embodiment shown, this axis of rotation is not defined by a shaft, but by two rotatably mounted and non-driven support rollers 54, 56, on which the ejector ring 52 can roll with its cylindrical outer surface.

The ejector ring 52 has the function of pushing the central electrode strip 12b, which has been slightly pressed into the interspace 50 by the first circular blades 32a, 32b, out of this space. This reliably prevents the electrode strip 12b from getting caught in the interspace 50 and winding onto the spacer element 43. Due to the eccentric arrangement of the axis of rotation 53 and the larger diameter of the ejector ring 52, the electrode strip 12b is continuously pressed out of the space 50 between the two circular blades 42a, 42b. A drive of the ejector ring 52 is generally not required, provided that the ejector ring 52 is mounted so smoothly that no major friction occurs between the radial outer surface of the ejector ring 52 and the electrode strip 12b during pressing out.

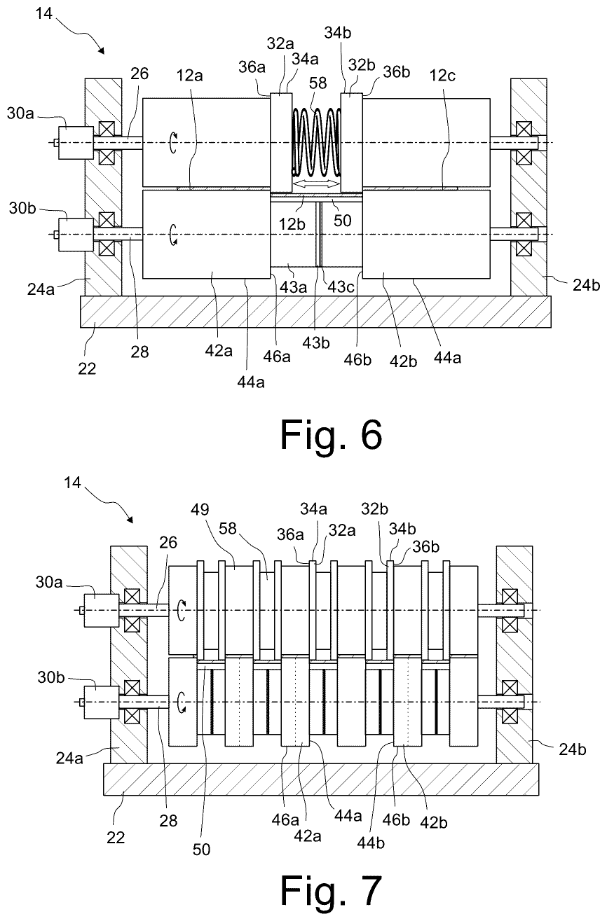

FIG. 6 shows, in a longitudinal section based on FIG. 2, a cutting device 14 according to a third embodiment, in which the two first circular blades 32a, 32b are not formed as one piece, but as separate components. An elastic element 58 is arranged between the two first circular blades 32a, 32b, which exerts a compressive force on the two first circular blades 32a, 32b acting towards the adjacent second circular blades 42a, 42b. In FIG. 6, this force effect is indicated by a double arrow.

The compressive force is dimensioned such that the side surfaces 36a, 36b of the first circular blades 32a, 32b are in close contact with the outer surfaces 46a, 46b of the respectively associated second circular blades 42a, 42b without excessive wear due to excessive friction. With the aid of the elastic element 58, the requirements for manufacturing accuracy can be reduced. It is even possible, within narrow limits, to change the width of the central electrode strip 12b without having to make changes to the first shaft 26. In the embodiment shown, the width of the interspace 50 is determined by several spacer elements 43a to 43c of different widths. If, for example, the width of the electrode strip 12b is to be reduced slightly by removing the narrowest spacer element 43c, the elastic element 58 ensures that the two first circular blades 32a, 32b can continue to interact with the second circular blades 42a, 42b.

In FIG. 6, the elastic element 58 is formed as a simple compression spring for reasons of clarity. In practice, other elastic elements are usually preferred, e.g. disk springs.

In the fourth embodiment shown in FIG. 7, the electrode strip 10 is not only cut into three, but into nine electrode strips. The structure shown in FIG. 6 only needs to be repeated several times in the axial direction. In this embodiment, the elastic element 58 is formed as a disk consisting of an elastomer.

While the first circular blades 32a, 32b are again formed as separate components as in the third embodiment shown in FIG. 6, a second circular knife 42a of a second group is now formed as a single piece with a circular knife 42b of an adjacent group. A virtual dividing line between two integrally formed second circular blades 42a, 42b is indicated by a dotted line.

In addition, ejector rings may be provided, as in the second embodiment shown in FIGS. 4 and 5, to support the ejection of the electrode strips from the spaces 50.

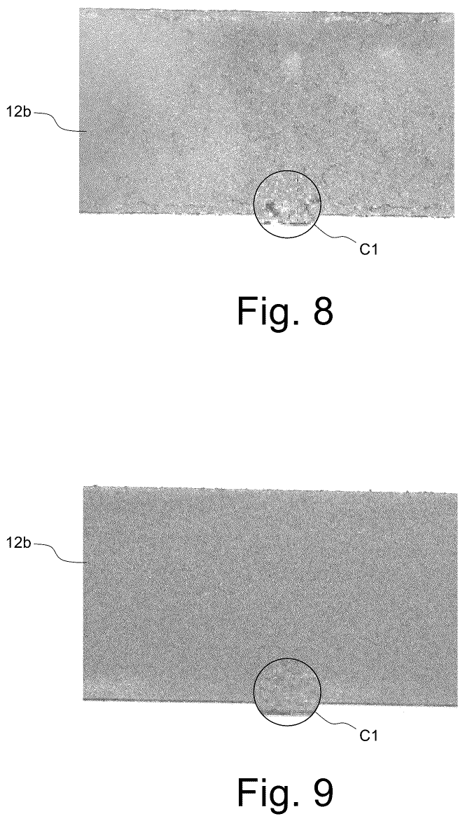

FIG. 8 shows a photograph of a section of an electrode strip configured as shown in FIG. 1a, which has been cut using a conventional cutting device. It is possible to recognize at the two cutting edges strip-shaped zones extending in the longitudinal direction, which are formed by the kinking of the electrode strip in the region of the conventional pointed cutting edges. As can be seen in the enlarged section C1, the cutting edge is heavily frayed in places and has clearly recognizable damage in the region of the porous coating.

FIG. 9 shows a corresponding photo of an electrode strip 12 that was cut with the cutting device 14 of the present disclosure. The strip-shaped damage caused by kinking does not occur with the cutting device 14 according to the present disclosure. In the enlarged section C2, it can be seen that the coating extends directly to the cutting edge and is undamaged. As a result, the electrode strip 12 shown in detail in FIG. 9 results in a battery cell of significantly higher quality after winding.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for cutting a strip-shaped electrode foil into narrower strips, wherein the device comprises:
a first shaft;
a second shaft extending parallel to the first shaft;
a drive configured to set the first shaft and the second shaft in counter-rotation;
a first pair of first circular blades that is attached to the first shaft in a rotationally fixed manner;
a second pair of second circular blades that is attached to the second shaft in a rotationally fixed manner; and
an elastic element that:
comprises an elastomer, a compression spring or a disk spring,
is arranged between the two first circular blades, and
exerts a pressure force on the first two circular blades that acts towards the adjacent second circular blades,
wherein each circular blade has a radially outwardly facing cylindrical outer surface and a flat annulus-shaped side surface that extends perpendicular to the respective axis of rotation and forms a circumferential cutting edge where it adjoins the outer surface,
wherein the cutting edges of the second circular blades of the second pair face each other and are separated from each other by a circumferential interspace having an axial width,
wherein the cutting edges of the first circular blades of the first pair face away from each other and engage in the circumferential interspace in such a way that adjacent first and second circular blades cooperate to produce a respective cutting edge in the electrode foil, and
wherein a non-destructively exchangeable spacer element is arranged between the two second circular blades of the second pair, thereby determining the axial width of the circumferential interspace.

2. The device of claim 1, comprising an ejector ring extending through the circumferential interspace, wherein the ejector ring is rotatably mounted about an axis of rotation that is independent of and arranged eccentrically to the second shaft.

3. The device of claim 2, wherein the ejector ring is supported on two rotatably mounted rollers.
